(19) United States
(12) Patent Application Publication
(10) Pub. No.: US 2016/0083973 A1
(43) Pub. Date: Mar. 24, 2016

(54) APPARATUS FOR OUTDOORSMEN

(71) Applicant: Northeast Ventures LLC, Mt. Clemens, MI (US)

(72) Inventor: Greg DILONE, JR., Mt. Clemens, MI (US)

(21) Appl. No.: 14/858,194

(22) Filed: Sep. 18, 2015

Related U.S. Application Data
(60) Provisional application No. 62/052,611, filed on Sep. 19, 2014.

(51) Int. Cl. E04H 15/00; A01M 31/02; E04H 15/44

(52) U.S. Cl. CPC E04H 15/001; E04H 15/44; A01M 31/025

(57) ABSTRACT

A multi-use apparatus for outdoorsmen including a common tub and at least one cover or canvas. The at least one cover cooperates with the common tub to define an enclosure for a user. The apparatus is operative in a transportation mode and a user enclosure mode. The tub may be oriented in a generally horizontal position for transport and a generally vertical position for hunting and the like. A single product that is provided that may be alternative oriented and equipped with multiple canvases to satisfy various hunting and fishing applications.

### CROSS-REFERENCE TO RELATED APPLICATIONS

This application claims the benefit of U.S. Provisional Patent Application No. 62/052,611 filed 19 Sep. 2015 and also claims priority to U.S. application Ser. No. 14/289,837 filed 29 May 2014, which applications are herein expressly incorporated by reference.

### FIELD

The present disclosure generally relates to an apparatus for outdoorsmen. The present disclosure more particularly relates to a multi-use apparatus for outdoorsmen that is easy to transport and may be used in various orientations to satisfy various hunting and fishing needs with a single product.

### BACKGROUND

Hunters and fishermen conventionally use various devices for transporting gear. To a limited extent, it is known in the art to provide a device for transporting hunting or fishing gear that may be converted into a shelter or blind. One such device is shown and described in commonly assigned U.S. Pat. No. 7,959,182. U.S. Pat. No. 7,959,182 is incorporated by reference as if fully set forth herein.

While known devices for transporting hunting and fishing gear, including but not limited to the device of U.S. Pat. No. 7,959,182, have proven to be suitable for their intended uses, a continuous need for advancement in the relevant arts is needed.

### SUMMARY

In accordance with one particular aspect, the present teachings provide a multi-use apparatus including a common tub and at least one cover. The at least one cover cooperates with the tub to define an enclosure for a user. The multi-use apparatus is operative in a transportation mode and a user enclosure mode.

In accordance with another particular aspect, the present teachings provide a multi-use apparatus for outdoorsmen including a tub and first, second, third and fourth adjustable legs. The adjustable legs are mounted to the tub. Each of the legs includes a mounting member and a telescopic member. Each mounting member non-rotatably mounted to the tub. The tub may be oriented in a generally horizontal position for transportation and a generally vertical position for hunting and the like.

In accordance with yet another particular aspect, the present teachings provide a multi-use apparatus for outdoorsmen. The apparatus includes a tub, a plurality of canopy supports and a canopy. The tub includes an open side and is orientable to a use position in which the open side is in a generally vertically extending plane. The canopy cooperates with the tub to define an enclosure. Each canopy support is pivotably coupled to the tub for movement between a stowed position and a deployed position. The plurality of canopy supports support the canopy.

### DRAWINGS

The drawings described herein are for illustrative purposes only of selected embodiments and not all possible implementations, and are not intended to limit the scope of the present disclosure.

FIG. 1 is a perspective view of an apparatus for outdoorsmen constructed in accordance with the present teachings.

FIG. 2 is another perspective view of the apparatus of FIG. 1.

FIG. 3 is a perspective view of a retractable handle assembly of the apparatus of the present teachings, it being understood that the handle assembly may additionally incorporate handle grips.

FIG. 4 is a plan view of the retractable handle assembly of the apparatus of the present teachings.

FIG. 5 is a perspective view of a front canopy support of the apparatus of the present teachings.

FIG. 6 is a plan view of the front canopy support of the apparatus of the present teachings.

FIG. 7 is a perspective view of a mid-canopy support of the apparatus of the present teachings.

FIG. 8 is a plan view of the mid-canopy support of the apparatus of the present teachings.

FIG. 9 is a perspective view of a rear canopy assembly of the apparatus of the present teachings.

FIG. 10 is a plan view of the rear canopy support of the apparatus of the present teachings.

FIG. 11 is a perspective view of a hitch support of the apparatus of the present teachings.

FIG. 12 is a perspective view of a frame assembly of the apparatus of the present teachings.

FIG. 13 is a plan view of the frame assembly of the apparatus of the present teachings.

FIG. 14 is a side view of the apparatus for outdoorsmen of the present teachings shown to include a cover.

FIG. 15 is a perspective view of the apparatus for outdoorsmen of the present teachings shown collapsed for transportation.

FIG. 16 is a view of the apparatus for outdoorsmen shown collapsed in a vehicle for transportation.

FIG. 17 is a view illustrating the apparatus for outdoorsmen of the present teachings being transported by a user.

FIG. 18 is another view illustrating the apparatus for outdoorsmen of the present teachings being transported by a user, the user additionally utilizing a shoulder harness.

FIG. 19 is another view illustrating the apparatus for outdoorsmen of the present teachings being transported by a user, the apparatus shown floating through shallow water.

FIG. 20 is a perspective view of the apparatus for outdoorsmen of the present teachings coupled to an all-terrain vehicle for towing.

FIG. 21 is a perspective view of the apparatus for outdoorsmen of the present teachings coupled to a snowmobile for towing.

FIG. 22 is a perspective view of the apparatus for outdoorsmen of the present teachings shown to include a hunting canvas and set up in a first orientation for hunting.

FIG. 23 is another perspective view of the apparatus for outdoorsmen of the present teachings shown in the hunting orientation of FIG. 22.

FIG. 23B is a rear view of the cover of FIGS. 22 and 23 illustrating the rear opening in the cover corresponding with the open upper side of the tub.

FIG. 24 is a perspective view similar to FIG. 24 illustrating the apparatus for outdoorsmen of the present teachings with the hunting canvas removed for purposes of illustration.

FIG. 25 is another view similar to FIG. 24 illustrating the apparatus for outdoorsmen of the present teachings to include an alternative hunting canvas for waterfowl hunting.

FIG. 26 is another perspective view of the apparatus for outdoorsmen of the present teachings including the alternative waterfowl hunting canvas of FIG. 25.

FIG. 27 is a perspective view of the apparatus for outdoorsmen of the present teachings including an ice fishing canvas and set up in a second orientation for ice fishing.

FIG. 28 is another perspective view of the apparatus for outdoorsmen of the present teachings shown in the ice fishing orientation of FIG. 27.

FIG. 29 is another perspective view of the apparatus for outdoorsmen of the present teachings shown in the ice fishing orientation of FIG. 27.

FIG. 30 is a perspective view of the apparatus for outdoorsmen of the present teachings including a bird watching canvas and set up in a third orientation for bird watching.

FIG. 31 is another view illustrating the apparatus for outdoorsmen of the present teachings being transported by a user, the apparatus equipped with skis.

FIG. 32 is another view illustrating the apparatus for outdoorsmen of the present teachings being transported by a user shown as just a sled.

FIG. 33 is a front perspective view of the apparatus for outdoorsmen of the present teachings shown in a hunting orientation accommodating two seated hunters.

FIG. 34 is a rear perspective view of the apparatus for outdoorsmen of the present teachings shown in the hunting orientation of FIG. 33.

FIG. 35 is a front perspective view of the apparatus for outdoorsmen of the present teachings shown in another hunting orientation accommodating two seated waterfowl hunters.

FIG. 36 is a rear perspective view of the apparatus for outdoorsmen of the present teachings shown in the hunting orientation of FIG. 35.

FIG. 37 is a front perspective view of the apparatus for outdoorsmen of the present teachings shown in an additional hunting orientation and including an alternate mounted seat.

FIG. 38 is a rear perspective view of the apparatus for outdoorsmen of the present teachings shown in the hunting orientation of FIG. 37.

FIG. 39 is a front perspective view of the apparatus for outdoorsmen of the present teachings shown in a further hunting orientation.

FIG. 40 is a rear perspective view of the apparatus for outdoorsmen of the present teachings shown in the hunting orientation of FIG. 39.

FIG. 41 is a view similar to FIG. 40, illustrating an alternative orientation for supporting the apparatus.

FIG. 42 is another view similar to FIG. 40, illustrating another alternative orientation for supporting the apparatus.

FIG. 43 is a front perspective view similar to FIG. 39 further illustrating an ability of the apparatus for outdoorsmen of the present teachings to accommodate a dog.

FIG. 44 is a front perspective view of the apparatus for outdoorsmen of the present teachings shown in an ice shanty orientation for two to three persons.

FIG. 45 is a rear perspective view of the apparatus for outdoorsmen of the present teachings shown in the ice shanty orientation of FIG. 45.

FIG. 46 is a front perspective view similar to FIG. 39 illustrating the apparatus for outdoorsmen of the present teachings with an alternative cover.

Corresponding reference numerals indicate corresponding parts throughout the several views of the drawings.

### DETAILED DESCRIPTION

Example embodiments will now be described more fully with reference to the accompanying drawings.

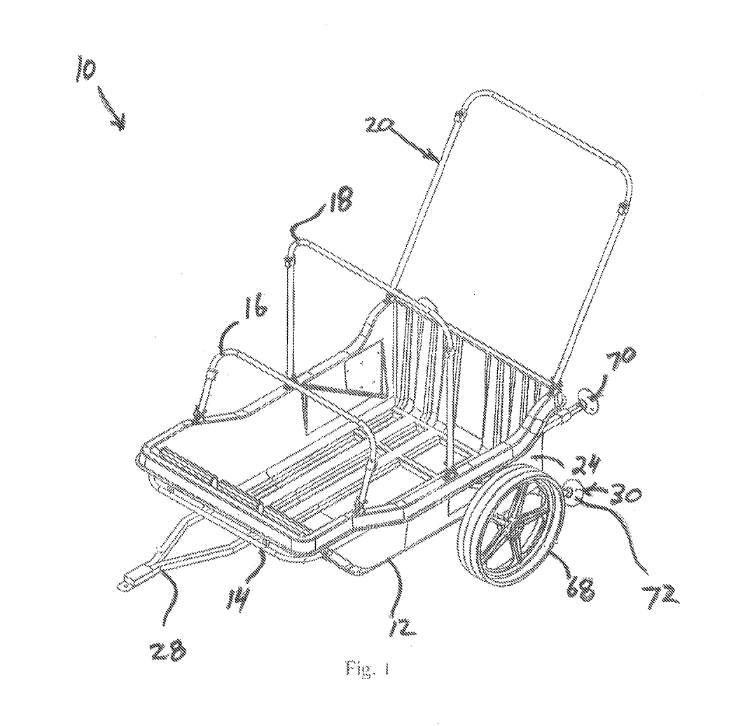

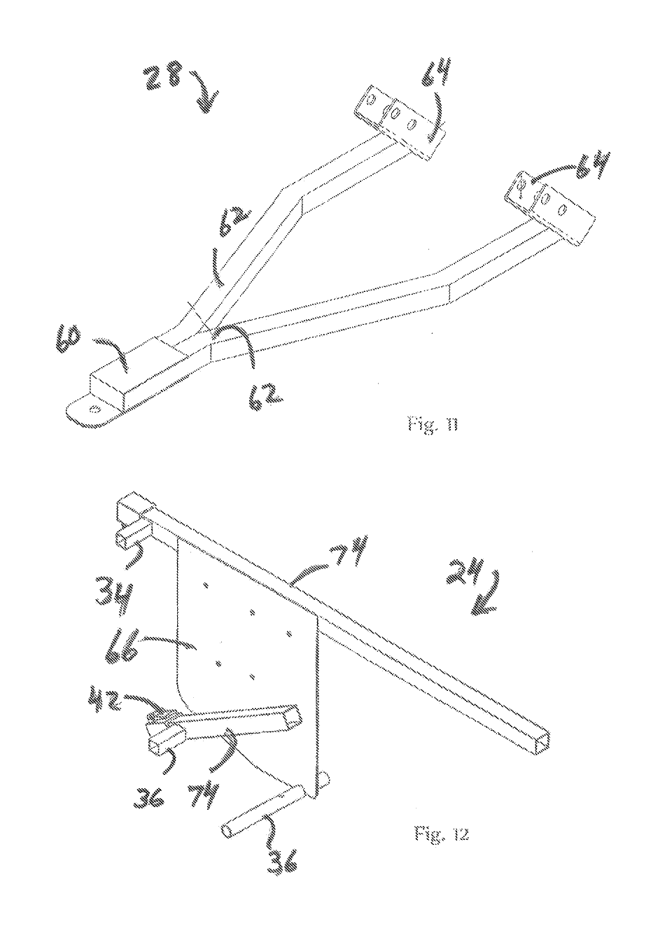

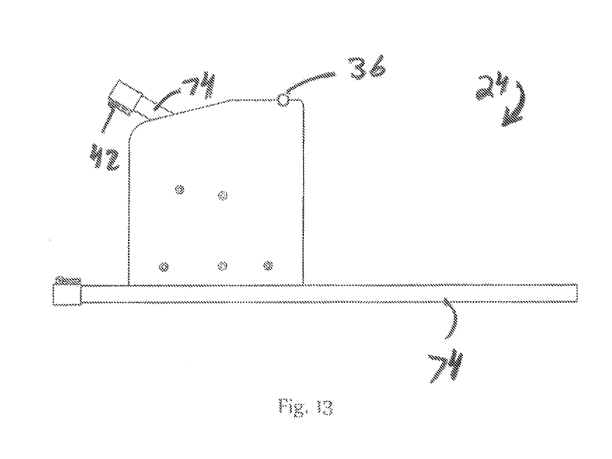

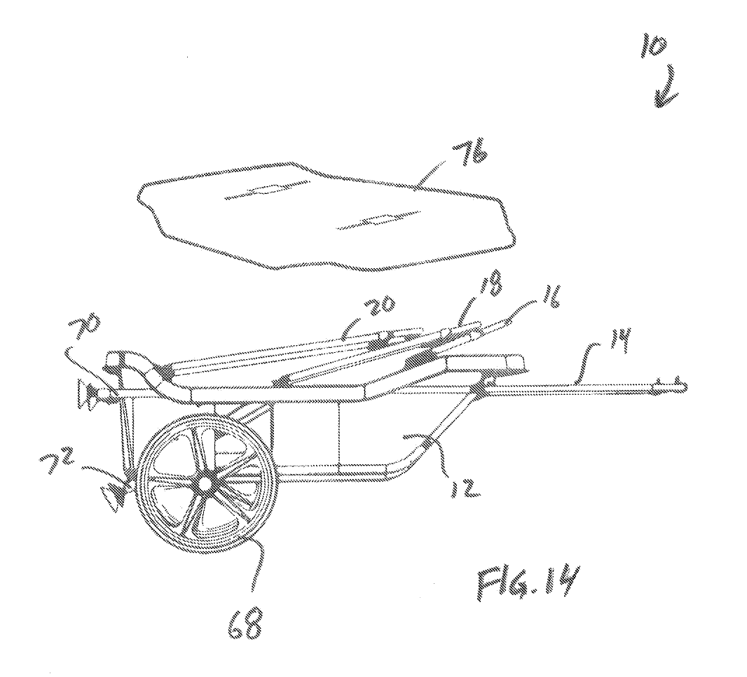

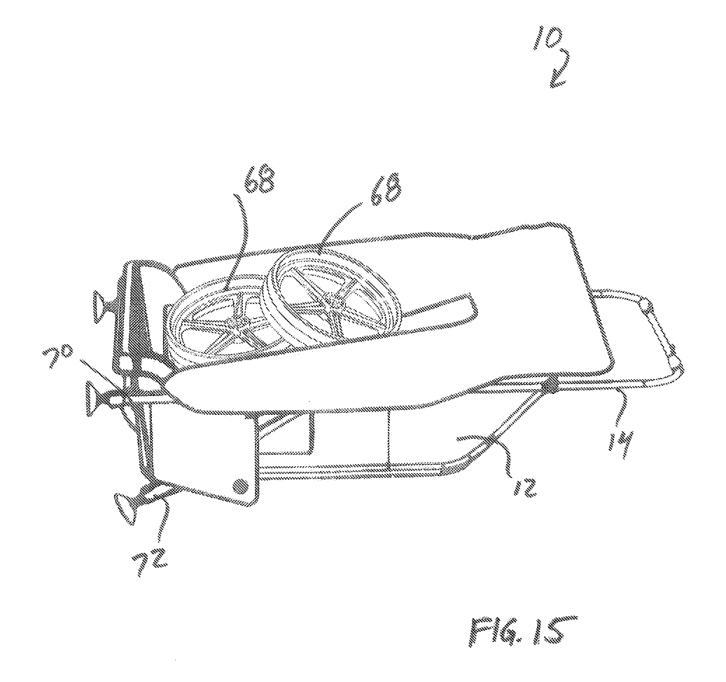

With initial reference to FIGS. 1 through 12, an apparatus for outdoorsmen constructed in accordance with the present teachings is illustrated and generally identified at reference character 10. The apparatus 10 is shown to generally include the following elements:
12 a tub
14 a retractable handle assembly
16 a front canopy support
18 a mid-canopy support
20 a rear canopy support
22 a wheel and axle assembly
24 a pair of frame assemblies
28 a hitch assembly
30 a support leg assembly
32 an axle tube
34 an upper tub support member
36 a lower tub support member

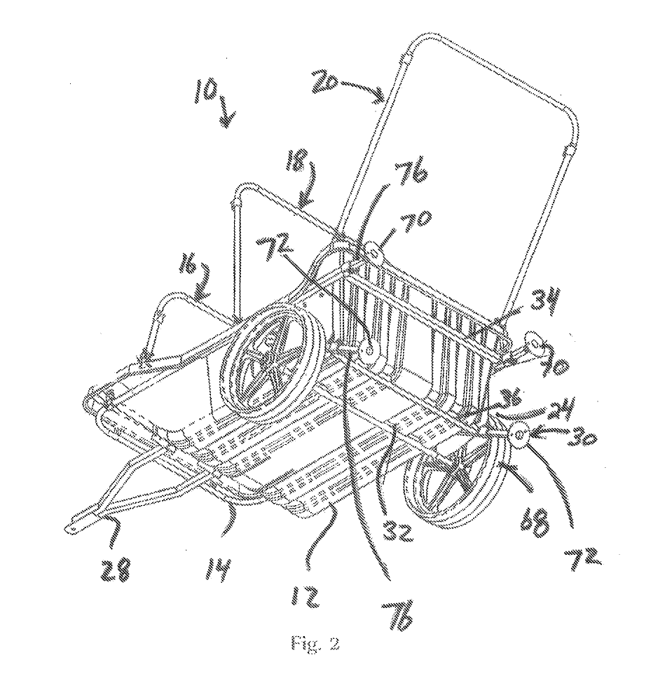

The tub 12 is constructed of plastic or other suitable material of sufficient strength and durability. As shown in FIGS. 1 and 2, for example, the tub 12 has a generally rectangular shape with an open upper side that provides access to a storage area. A lip may peripherally surround the open upper side. The storage area is defined by a bottom wall, a pair of side walls, a rear wall and a forward wall. The front wall may be angled relative to the bottom wall.

As is well known in the art, the tub 12 may be reinforced with structural members or braces to provide additional strength or for purposes of securing various elements to the tub 12. For example, the upper tub support member 34 and the lower tub support member 36 are provided.

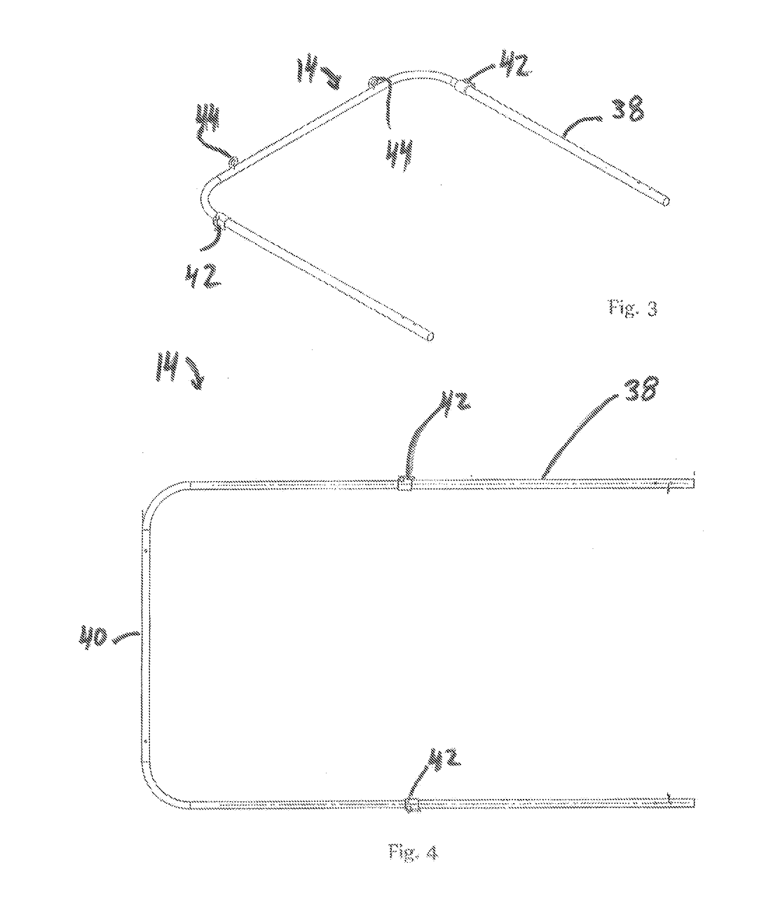

With particular reference to FIGS. 1 through 4, the retractable handle assembly 14 will be further described. The retractable handle assembly 14 is illustrated to generally include a pair of mounting tubes 38 and a handle 40. The mounting tubes 38 may be securely fastened to the tub 12 in any manner well known in the art. In the embodiment illustrated, the mounting tubes 38 are circular in cross section. It will be understood, however, that alternative cross sections may be employed within the scope of the present teachings. The handle 40 is generally U-shaped having a pair of legs connected by an intermediate portion. The legs have a cross section that cooperates with the mounting tubes 38 for telescopic adjustability. Thus, in the embodiment illustrated, the legs have a circular cross section. The legs are telescopically received within the mounting tubes 38. Latches 42 may be carried by both of the mounting tubes 38 for retaining the handle 40 in a desired telescopic position relative to the mounting tubes 38. Eyehooks 44 may be carried on the handle 40. A fully retracted orientation of the handle assembly 14 is shown in FIG. 3, for example. A fully extended orientation of the handle assembly 14 is shown in FIG. 4, for example.

With particular reference to FIGS. 1, 2 and 5-10, the front, mid and rear canopy supports 16, 18 and 20 will be further described. As will be appreciated below, each of the canopy supports 16, 18 and 20 is pivotably coupled to the tub 12 for movement between a stowed position and a deployed position. Further, each of the canopy supports 16, 18 and 20 may be extendable. As will be appreciate more fully below, the front, mid and rear canopy supports 16, 18 and 20 cooperate to adjustably support a canvas or canopy.

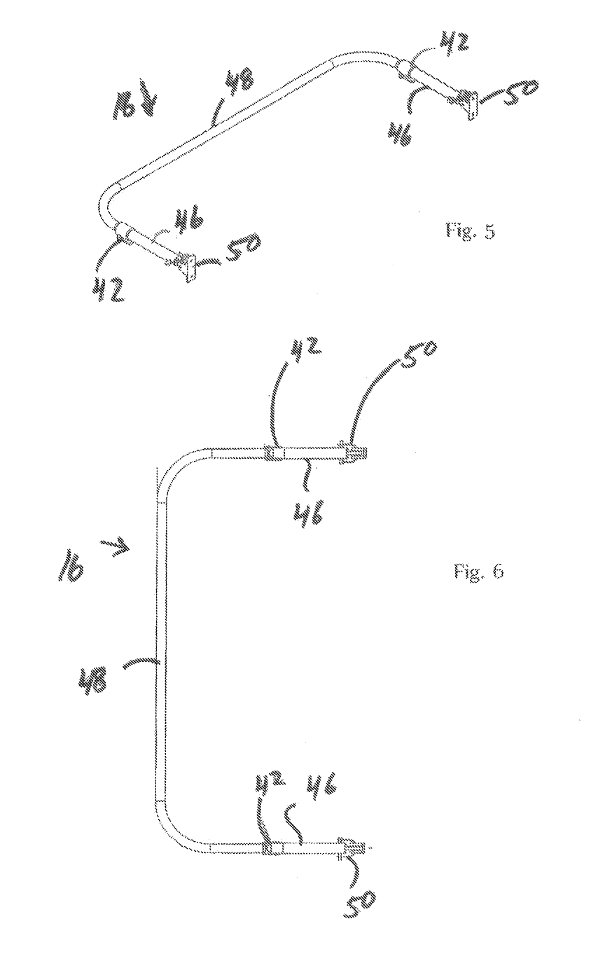

The front canopy support 16 is shown most particularly in FIGS. 1, 2, 5 and 6. The front canopy support 16 is illustrated to generally include a pair of mounting tubes 46 and a cross member 48. The mounting tubes 46 may be pivotally coupled to the tub 12 with suitable mounting brackets 50 and any necessary bracing. In the embodiment illustrated, the mounting tubes 46 are circular in cross section. It will be understood, however, that alternative cross sections may be employed within the scope of the present teachings. The cross member 48 is generally U-shaped having a pair of legs connected by an intermediate portion. The legs have a cross section that cooperates with the mounting tubes 46 for telescopic adjustability. Thus, in the embodiment illustrated, the legs have a circular cross section. The legs are telescopically received within the mounting tubes 46. Latches 42 may be carried by both of the mounting tubes 46 for retaining the cross member 48 in a desired telescopic position relative to the mounting tubes 46. A retracted orientation of the cross member 48 is shown in FIG. 5, for example. An extended orientation of the cross member 48 is shown in FIG. 6, for example.

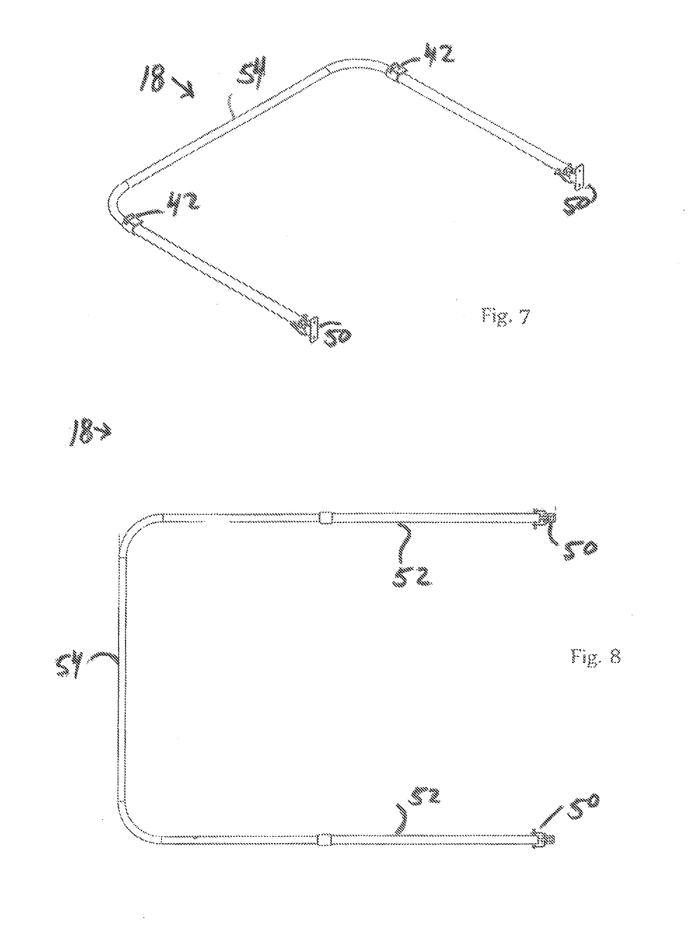

With particular reference to FIGS. 1, 2, 7 and 8, the mid-canopy support 18 will be further described. The mid-canopy support 18 is illustrated to generally include a pair of mounting tubes 52 and a cross member 54. The mounting tubes 52 may be pivotally coupled to the tub 12 with suitable mounting brackets 50 and any necessary bracing. In the embodiment illustrated, the mounting tubes 52 are circular in cross section. As illustrated, the mounting tubes 52 are longer than the mounting tubes 46. It will be understood, however, that alternative cross sections may be employed within the scope of the present teachings. The cross member 54 is generally U-shaped having a pair of legs connected by an intermediate portion. The legs have a cross section that cooperates with the mounting tubes 52 for telescopic adjustability. Thus, in the embodiment illustrated, the legs have a circular cross section. The legs are telescopically received within the mounting tubes 52. Latches 42 may be carried by both of the mounting tubes 52 for retaining the cross member 54 in a desired telescopic position relative to the mounting tubes 52. A retracted orientation of the cross member 54 is shown in FIG. 7, for example. An extended orientation of the cross member 54 is shown in FIG. 8, for example.

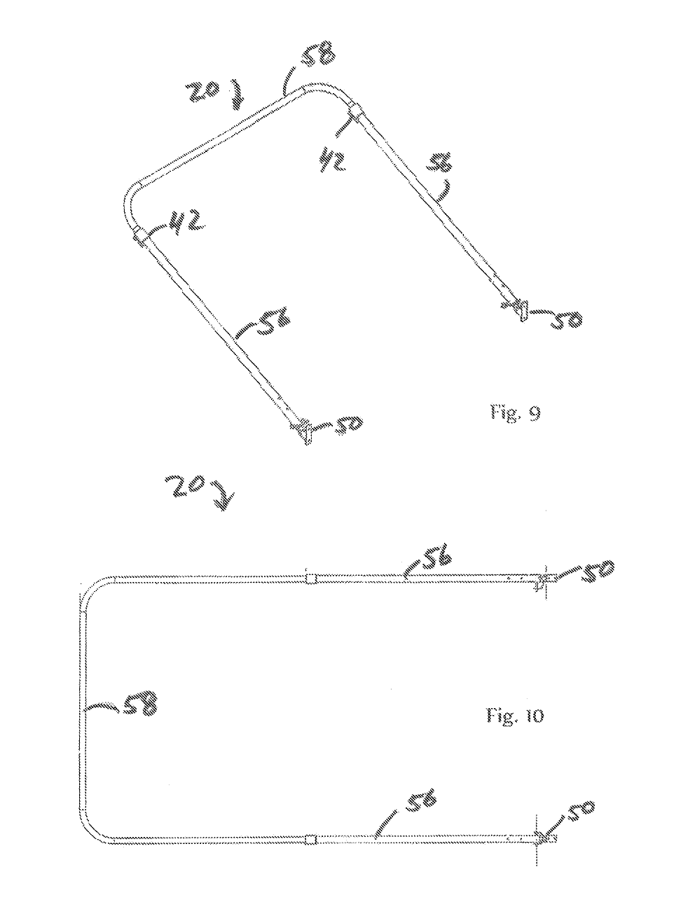

With particular reference to FIGS. 1, 2, 9 and 10, the rear canopy support 20 will be further described. The rear canopy support 20 is illustrated to generally include a pair of mounting tubes 56 and a cross member 58. The mounting tubes 56 may be pivotally coupled to the tub 12 with suitable mounting brackets 50 and any necessary bracing. In the embodiment illustrated, the mounting tubes 56 are circular in cross section. As illustrated, the mounting tubes 56 are longer than the mounting tubes 52. It will be understood, however, that alternative cross sections may be employed within the scope of the present teachings. The cross member 58 is generally U-shaped having a pair of legs connected by an intermediate portion. The legs have a cross section that cooperates with the mounting tubes 56 for telescopic adjustability. Thus, in the embodiment illustrated, the legs have a circular cross section. The legs are telescopically received within the mounting tubes 56. Latches 42 may be carried by both of the mounting tubes 56 for retaining the cross member 58 in a desired telescopic position relative to the mounting tubes 56. A retracted orientation of the cross member 56 is shown in FIG. 9, for example. An extended orientation of the cross member 58 is shown in FIG. 10, for example.

With particular reference to FIGS. 1, 2 and 11, the hitch assembly 28 will be further described. The hitch assembly 28 is shown to generally include tongue 60 for coupling to a towing vehicle. The hitch assembly further includes a pair of hitch arms 62. Each of the hitch arms 62 carries a mounting bracket 64. The mounting brackets 64 may be welded to or otherwise securely fastened to the hitch arms 62. In the embodiment illustrated, the mounting brackets 64 are U-shaped. The mounting brackets 64 may be secured to the tub 12 with fasteners and any required bracing.

The hitch arms 62 may both be disposed in a common plane. The mounting brackets 64 may be angled relative to this common plane such that the U-shapes of the mounting brackets 64 define channels correspondingly angled relative to the common plane. The channels defined by the mounting brackets 64 may receive protrusions of the tub 12 to facilitate attachment thereto.

With particularly reference to FIGS. 1, 2, 12, and 13 the frame assembly 24 for the left side of the tub 12 will be further described. It will be understood that the frame assembly 24 for the right side of the tub 12 may be a mirror image thereof. In the embodiment illustrated, the frame assembly 24 for the right side of the tub 12 is a mirror image of the frame assembly for the left side of the tub 12. The frame assembly 24 is illustrated to include plate 66 that may be secured to the tub 12 with fasteners or in any other manner well known in the art. The plate 66 may be welding or otherwise secured to the lower tub support member 36. The plate 66 may also be welded or secured to elements of the support leg assembly 30 as will be described further below.

The wheel and axle assembly 24 is shown to include an axle and a pair of wheels 68. The axle passes through the axle tube 32 which is secured to the tub 12. In this manner, the axle may be rotatably coupled to the tub 12.

The support leg assembly includes a plurality of legs. As shown, the plurality of legs includes first, second, third and fourth adjustable legs. Each leg includes a mounting portion and a telescopic portion. Each telescopic portion may be non-rotatably attached to the tub 12.

The plurality of legs of the support leg assembly 30 define a first pair of legs or a pair of forward legs 70 and a second pair of legs or a pair of rear legs 72. Each of the legs 70 and 72 includes a mounting member 74 and an extendable member or telescopic member 76. The mounting members 74 may be welded or otherwise non-movably secured to the plate 66 of the frame assemblies 24. In the embodiment illustrated, the mounting members 74 are rectangular in cross section. It will be understood, however, that alternative cross sections may be employed within the scope of the present teachings. The extendable members 76 have a cross section that cooperates with the mounting members 74 for telescopic adjustability. Thus, in the embodiment illustrated, the extendable members 76 have a rectangular cross section. The extendable members 76 are telescopically received within the mounting members 74. Latches 42 may be carried by the mounting members 74 for retaining the extendable members 76 in a desired telescopic position relative to the mounting member 74. Importantly, each of the extendable members 76 is independently adjustable relative to a respective mounting member 74. In this manner, the support leg assembly 30 may accommodate for uneven ground.

With reference to FIG. 14, the apparatus 10 of the present teachings is shown to include a tarp or cover 76 for covering the tub 12 during transportation, for example. In this configuration, the front, mid and rear canopy supports 16, 18 and 20 are articulated to stowed or transport positions generally parallel to the top of the tub 12. The tarp 76 may cooperate with a lip that extends around an upper edge of the tub 12. The tarp 76 may conventionally include an elastic member for securement to the tub 12. In this transportation mode and other transportation modes described herein, the tub may be oriented in a generally horizontal position.

With reference to FIG. 15, the apparatus 10 is shown with the wheels 68 removed. In this orientation, the tub 12 may function as a sled or may buoyantly be used in water. The wheels 68 may be carried on the cover 76.

With reference to FIG. 16, of the apparatus 10 of the present teachings is shown collapsed in a vehicle for transportation. The apparatus 10 may be dimensioned to fit into a standard sport utility vehicle (SUV).

With reference to FIG. 17, the apparatus 10 of the present teachings is shown being transported by a user. The handle 40 is extended.

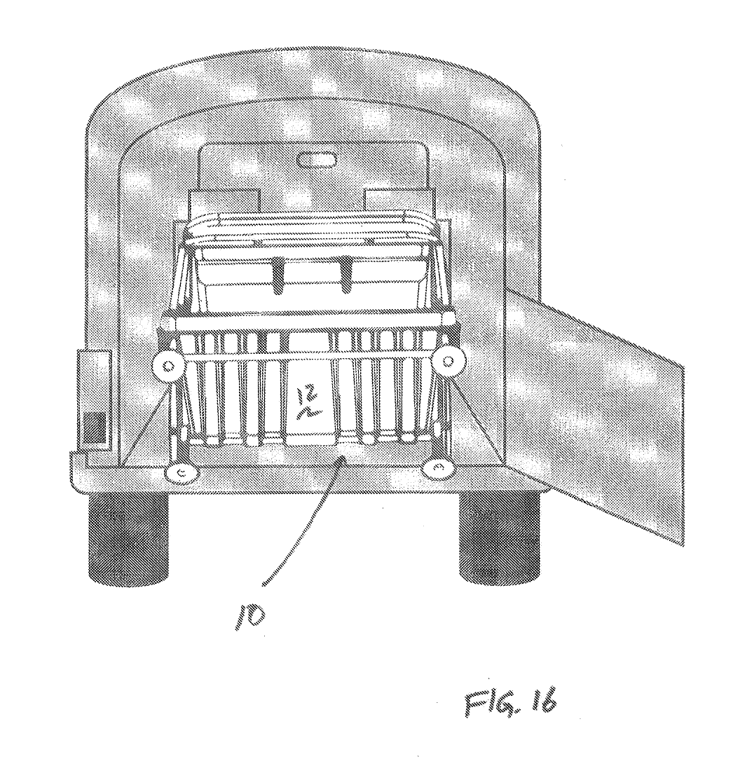

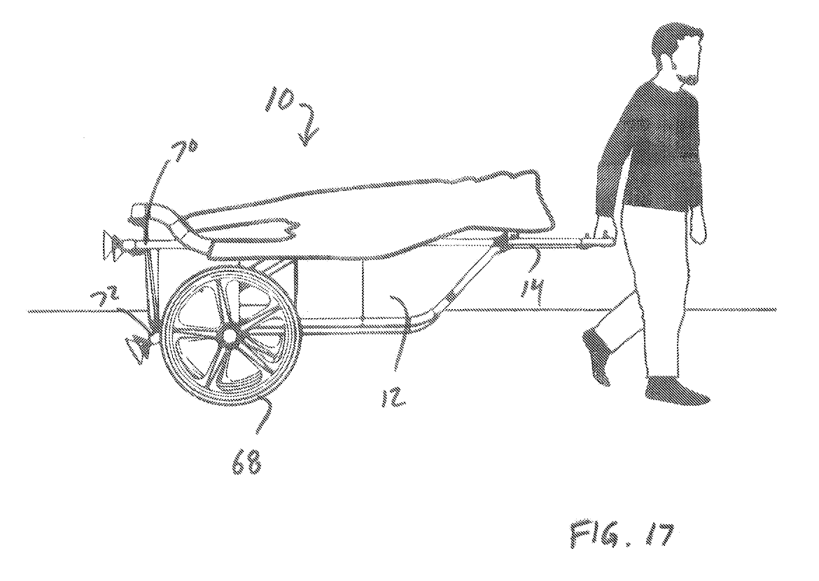

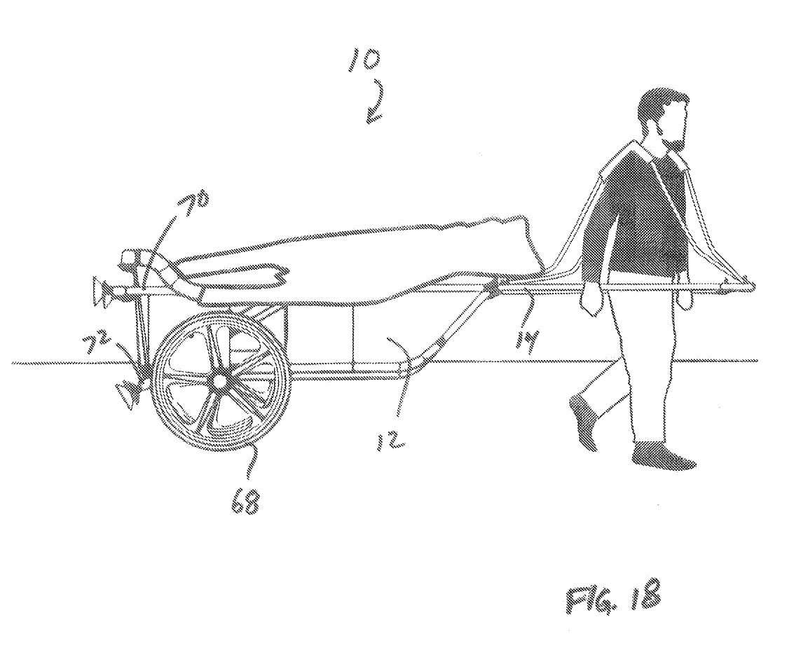

With reference to FIG. 18, the apparatus 10 of the present teachings is again shown being transported by a user. As shown in this view, the user additionally may utilize a shoulder harness.

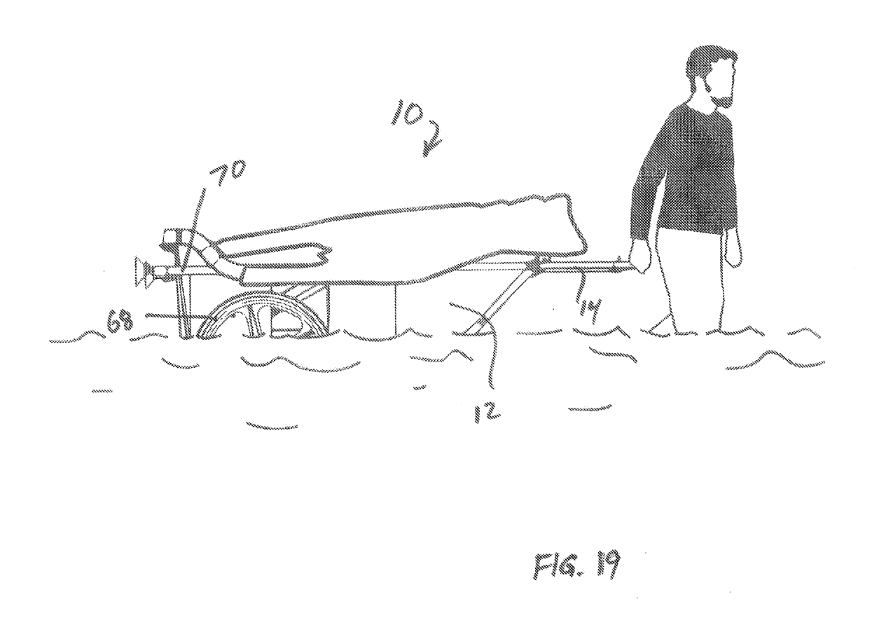

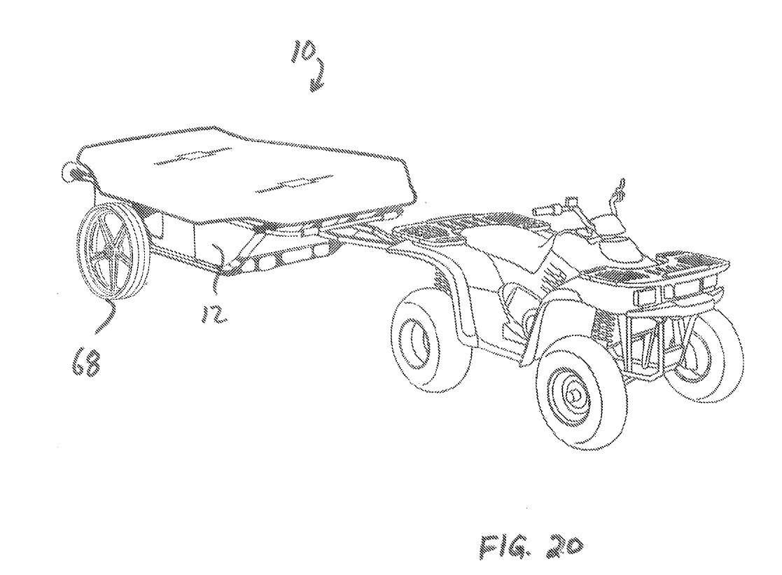

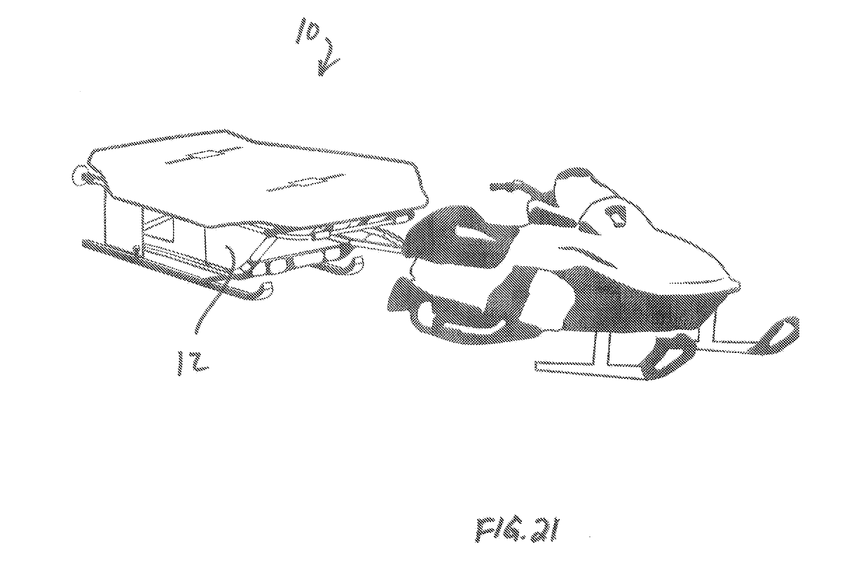

With reference to FIG. 19, the apparatus 10 of the present teachings is again shown being transported by a user. As shown in this view, the tub 12 may provide buoyance for transporting the apparatus 10 in water. The apparatus 10 may be used in this mode with or without the wheels 68 carried by the tub 12.

With reference to FIGS. 20 and 21, the apparatus 10 of the present teachings is shown operatively coupled to a vehicle for towing. In FIG. 20, the exemplary vehicle is illustrated as an all-terrain vehicle. In FIG. 21, the exemplary vehicle is illustrated as a snowmobile. FIG. 21 further illustrates that the apparatus 10 may be alternatively equipped with a sled assembly including a pair of skis. It will be appreciated that the sled assembly may be secured to the tub 12 in a manner similar to that used to secure the wheel and axle assembly 22 to the tub 12.

It will be understood that the present teachings provide an apparatus that has a common tub 12. The common tub 12 may be adapted for various specific uses. The common tub 12 may cooperate with one or more covers to define an enclosure for a user. The apparatus 10 may be operative in a first mode or transportation mode as shown and described through various examples herein. The apparatus 10 may be also operative in a second mode or user enclosure mode for concealing and/or protecting a user for hunting activities and the like. Various examples of such second modes are described below.

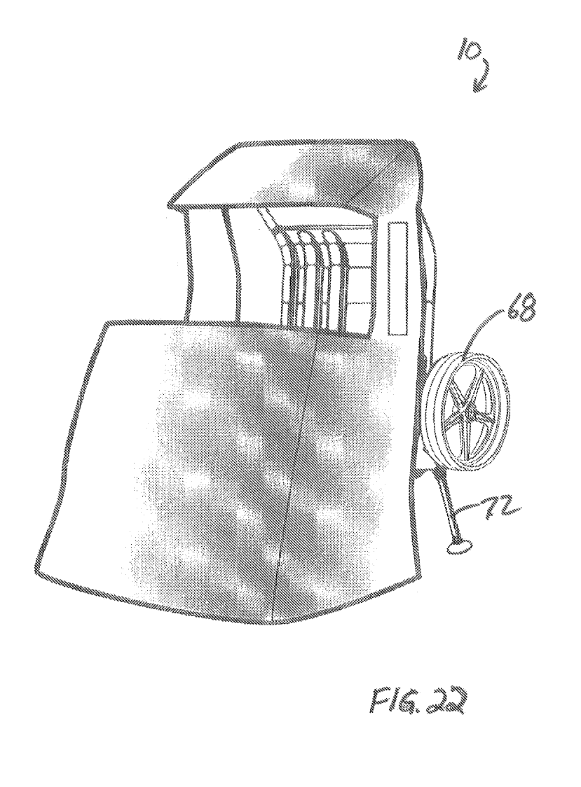

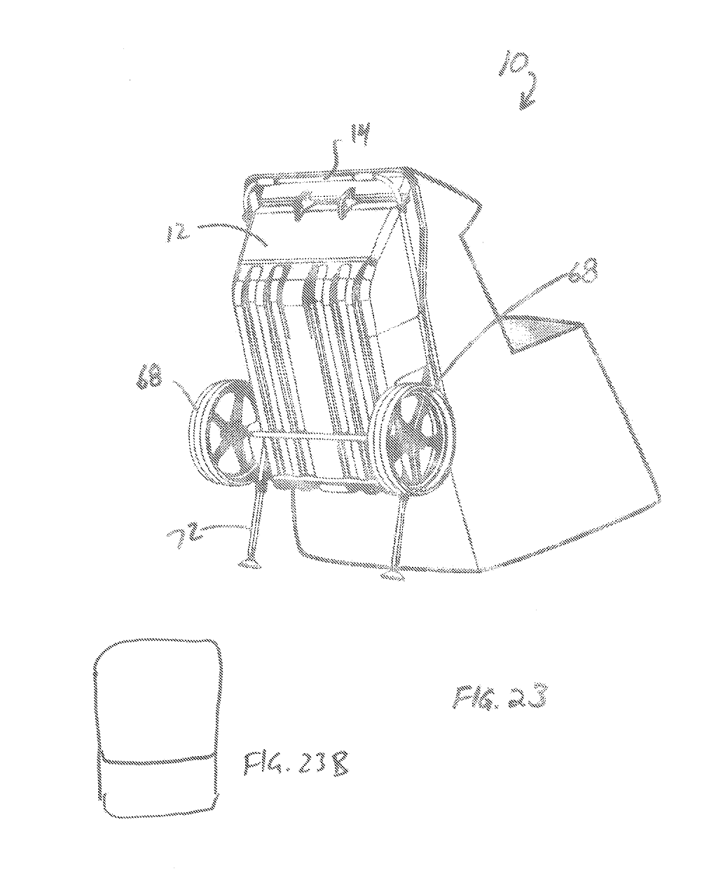

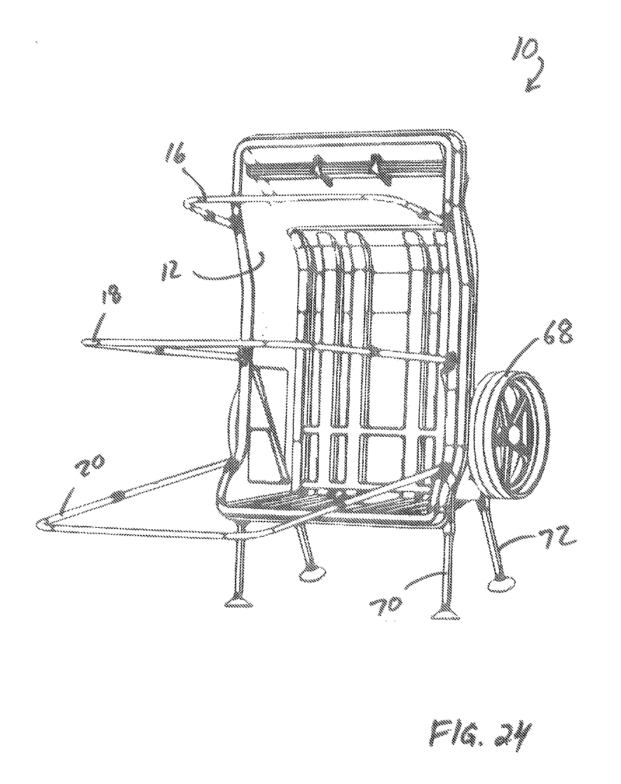

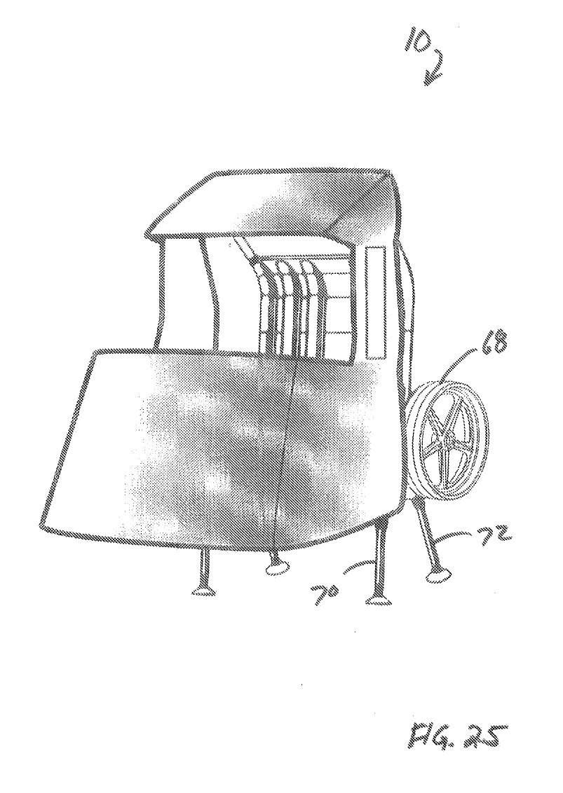

With reference to FIGS. 22 through 24, the apparatus 10 of the present teachings is shown in an exemplary use orientation or user enclosure mode. In this orientation, the apparatus 10 may be used for hunting, for example. FIGS. 22 and 23 show the apparatus 10 operatively associated with a canvas or cover. It will be understood that the terms canvas and cover are used interchangeably throughout. FIG. 24 is a view similar to FIG. 22 showing the apparatus without the canvas. The canvas cooperatives with the tub 12 to define an enclosure for protecting and/or concealing one or more users. The front, mid and rear canopy supports 16, 18 and 20 cooperate to adjustably support the canvas. As shown in FIG. 24, each of the canopy supports 16, 18 and 20 is oriented in a generally horizontal plane. The front support 16 may be located above an opening in a forward side of the cover. The mid and rear supports 18 and 20 may be located below the opening. The apparatus 10 may be used for gun hunting, crossbow hunting or the like.

In this use orientation illustration, the tub 12 is positioned generally vertically. Within the scope of the term “generally vertically”, it can be seen that the tub 12 may angle rearwardly as it extends upward to best accommodate the users in the cover. The legs 72 may be independently adjusted to best orient the tub 12 and to accommodate any unlevel ground.

The cover may be secured about an upper edge of the tub 12 and may include a rearward opening corresponding to the open, upper side of the tub 12. The rear canopy support 20 may define a largest perimeter of the cover in the use position. The mid-canopy support 18 may define an intermediate perimeter positioned immediately below the forward opening of the cover. The front canopy support 16 may define a smaller opening of the canopy. As shown in FIG. 23B, the cover may have a rear opening sized to cooperate with the open upper side of the tub 12. The perimeter of the cover defining the rear opening in the cover may be placed about the upper lip that peripherally surrounds the open upper side. The cover may be returned to the tub with elastic, fasteners, or in any other known manner. As such, the enclosure cooperatively defined by the tub 12 and the cover is defined by the storage area of the tub 12 and an interior of the cover. The cover peripherally surrounds the open side of the tub 12. The rear opening of the cover aligns with the open side.

As shown, when supported by the canopy supports 16, 18, 20, the cover includes a rear side, a pair of lateral sides and a front side. The opening is spaced from a bottom of the cover and laterally extends across the rear side such that the complete open side of the tub is open to the interior of the cover.

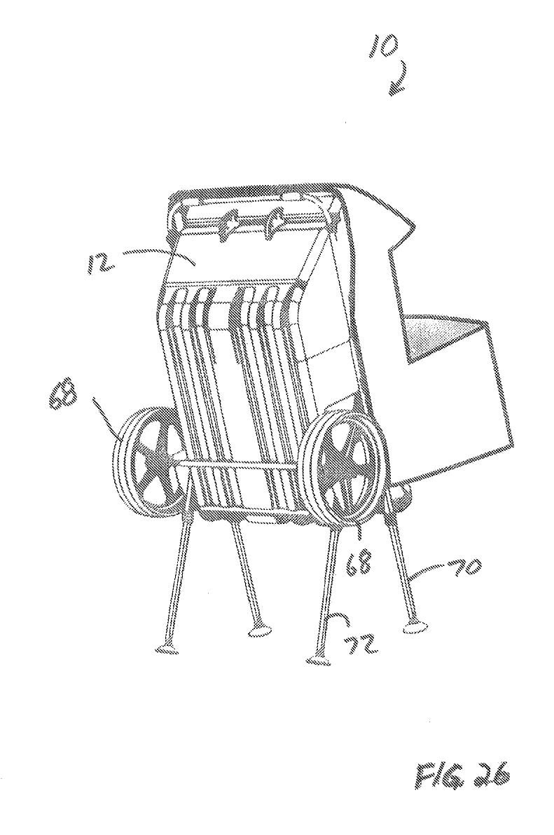

With reference to FIGS. 25 and 26, the apparatus 10 of the present teachings is shown operatively associated with an alternative canvas. The alternative canvas may be particularly adapted for waterfowl hunting, for example. FIG. 26 shows longer legs at 22″ from a standard height of 16″. As before, the cover includes a front opening on a front side thereof and a rear opening that cooperates with the open side of the tub 12.

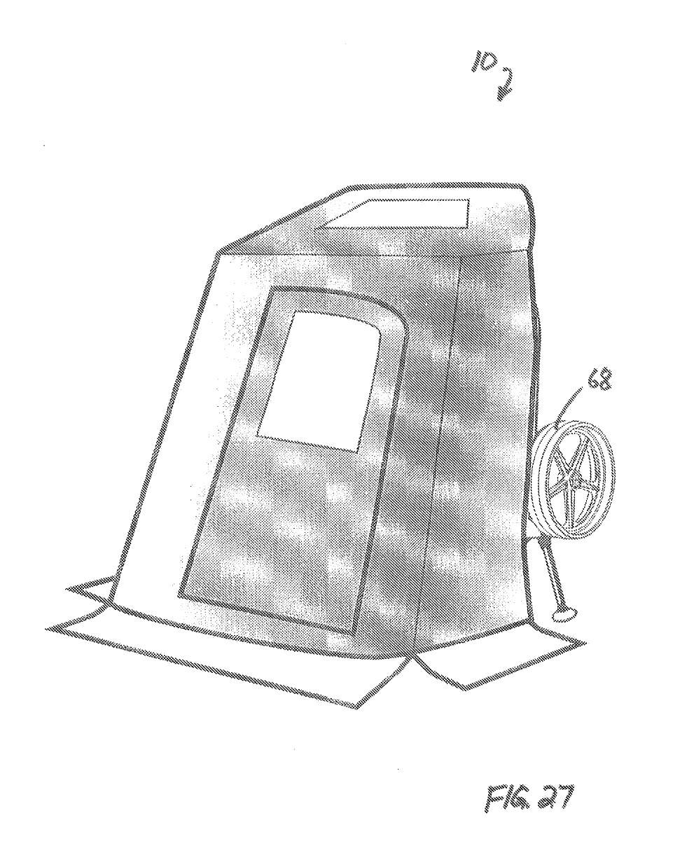

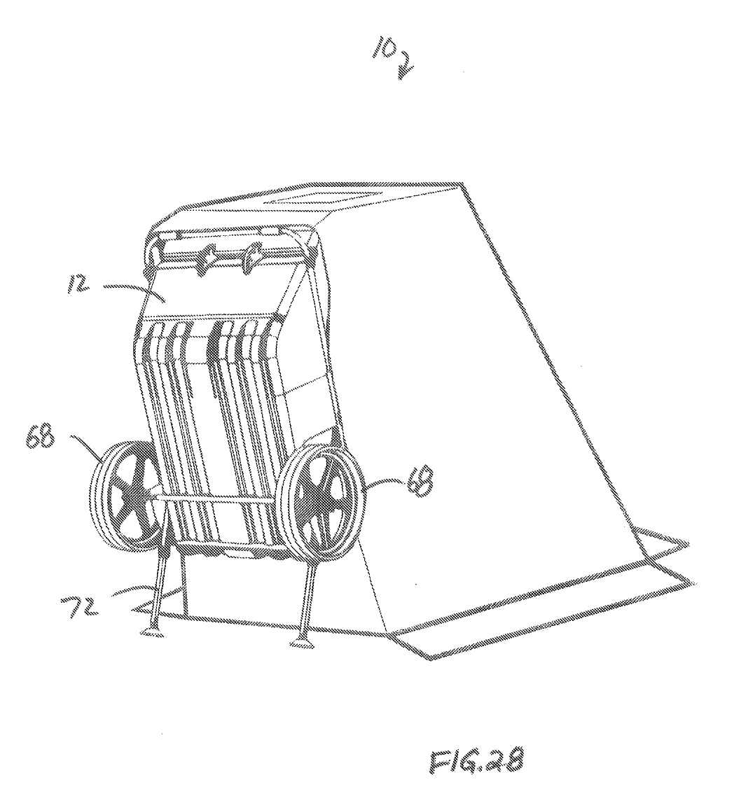

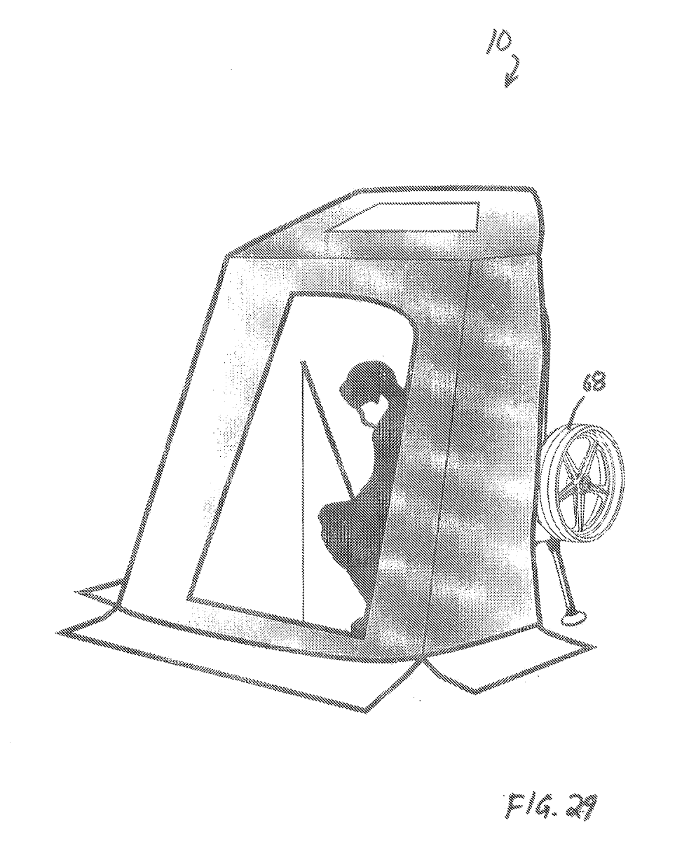

With reference to FIGS. 27 through 29, the apparatus 10 of the present teachings is shown operatively associated with another alternative canvas. The alternative canvas may be particularly adapted for ice fishing, for example. Again, the cover includes a front opening on a front side thereof and a rear opening that cooperates with the open side of the tub 12.

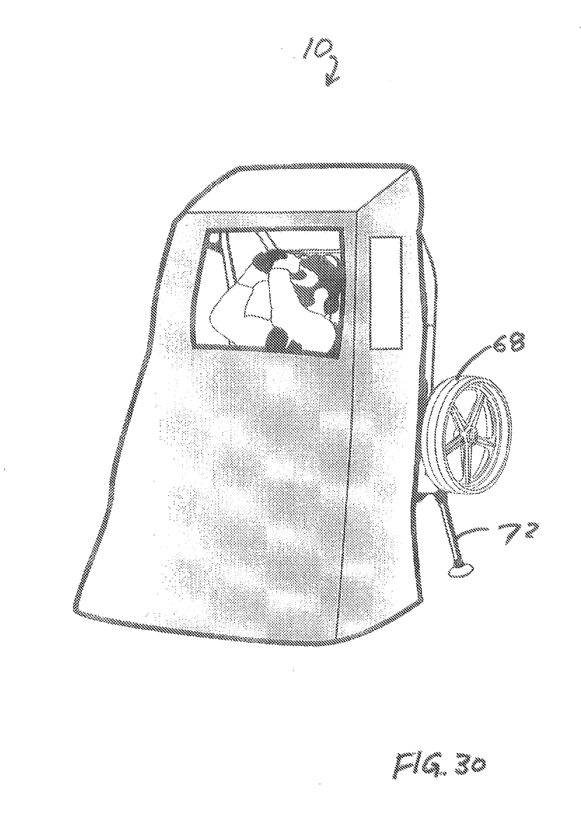

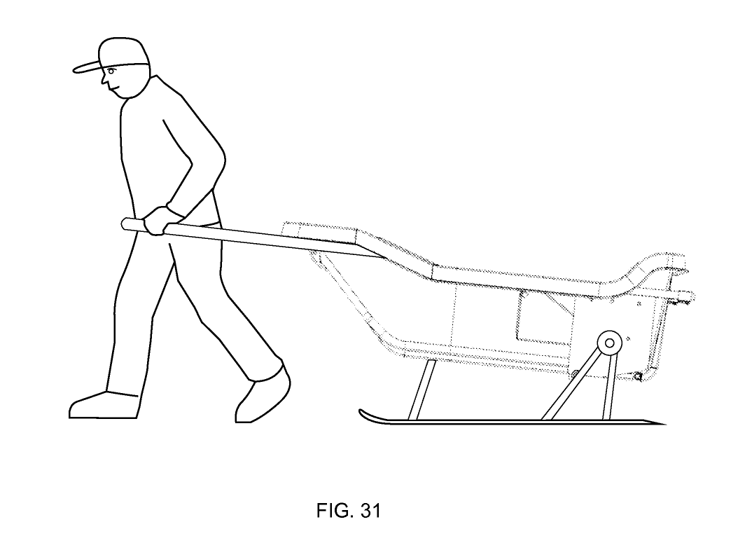

With reference to FIG. 30, the apparatus 10 of the present teachings is shown oriented for bird watching, for example. In this orientation, the apparatus 10 may also be used for hunting filming and other activities, for example.

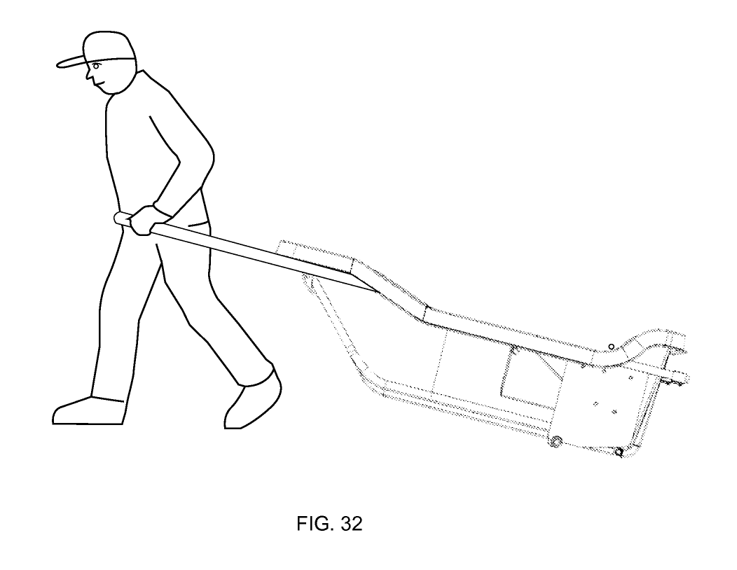

With reference to FIGS. 31 and 32, two additional modes for transporting the apparatus 10 of the present teachings by a user are illustrated. In FIG. 31, the apparatus 10 is equipped with skis. In FIG. 32, the apparatus 10 is simply dragged without the benefit of skis, or wheels.

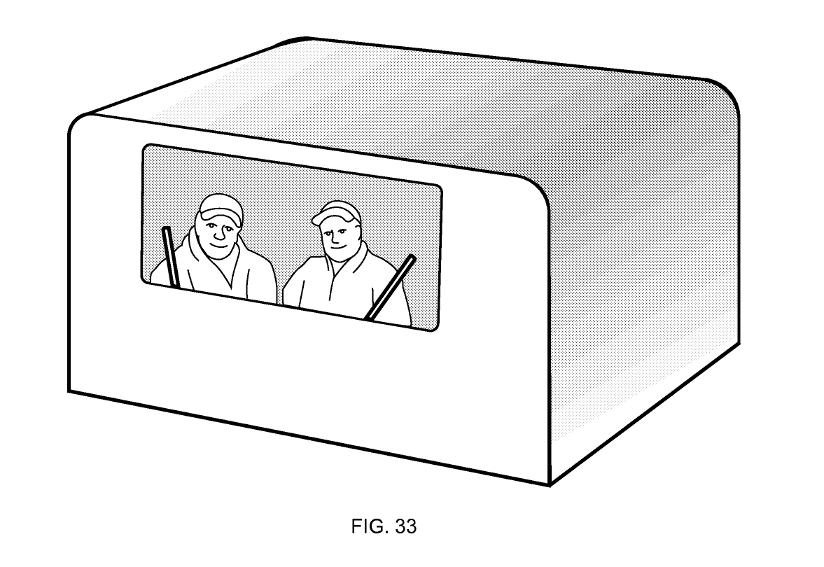

Turning to FIGS. 33 through 43, various other orientations are shown to illustrate the flexibility of the apparatus 10 of the present teachings to be used for various purposes. It will be understood that the structure underneath the canopies throughout these views are identical to the structures described above. In other words, FIGS. 33 through 43 still yet illustrate the flexibility of the apparatus 10 of the present teachings through various orientations and by using various canvases to accommodate varied uses with a single product.

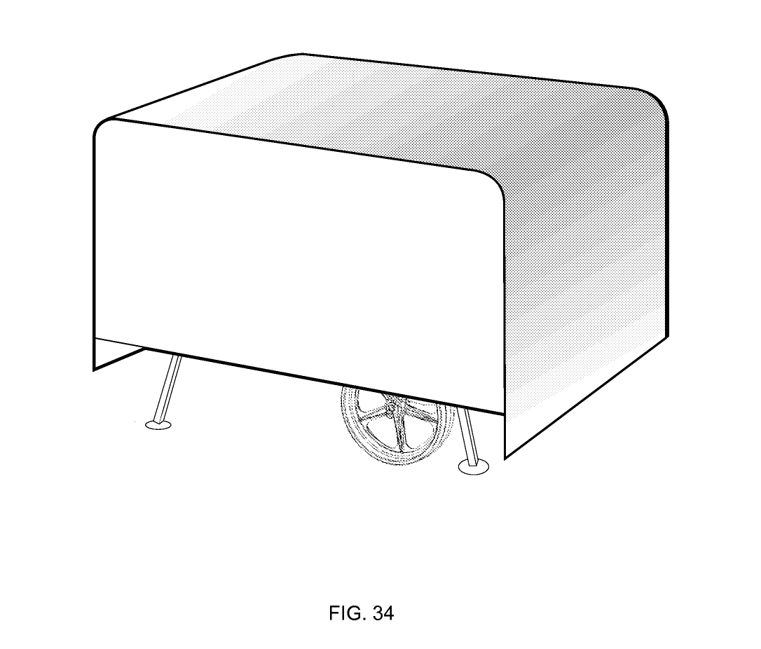

With reference to FIGS. 33 and 34, the apparatus for outdoorsmen of the present teachings is shown in a hunting orientation accommodating multiple seated hunters. As compared to other use orientations, the tub 12 may be oriented generally horizontally. The tub 12 for this embodiment is common with prior described embodiments. While not shown in particular detail with respect to this embodiment, the plurality of support legs may be alternatively mounted to the tub 12. In this regard, the tub 12 is oriented generally horizontally and the support legs extend downwardly. As before, each of the legs may be independently adjustable. The legs may be attached to the tub 12 in any manner well known in the art.

As illustrated, the hunting orientation may accommodate two seated hunters. For example, the orientation of FIGS. 33 and 34 may be used for deer hunting. The canvas shown in these figures may extend down to the ground in the front and along the sides. Further, the canvas need not extend down to the ground in the rear.

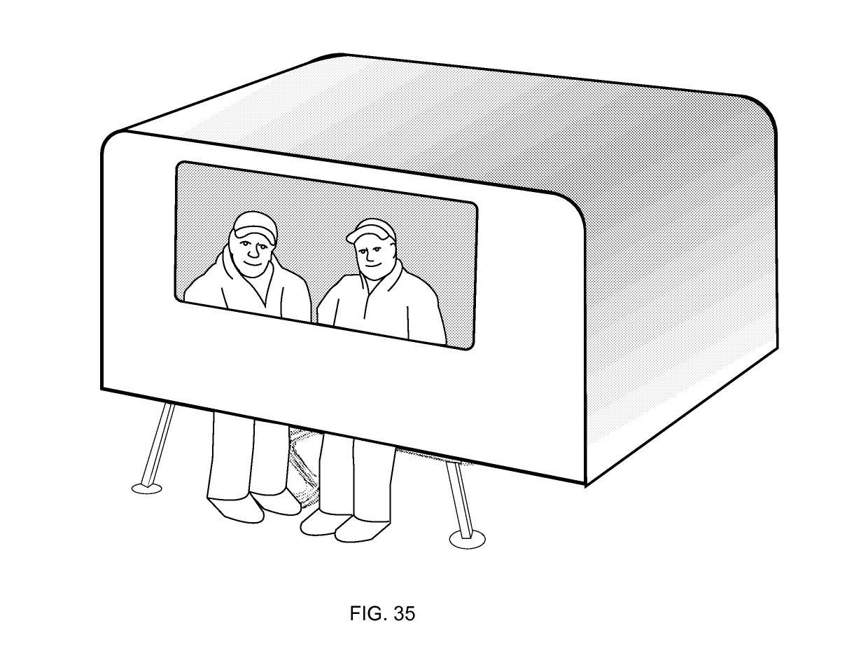

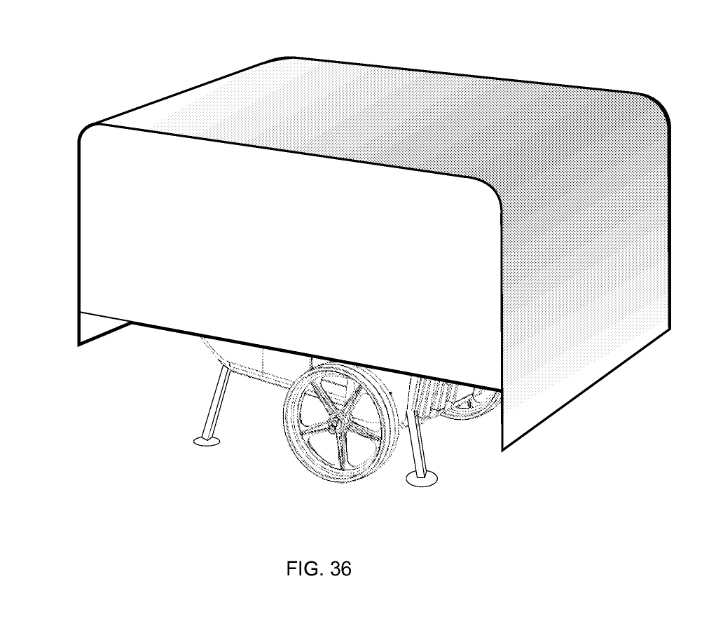

With reference to FIGS. 35 and 36, the apparatus for outdoorsmen of the present teachings is shown in another hunting orientation accommodating multiple seated hunters. Again, the hunting orientation is particularly shown to accommodate two seated hunters. The orientation of FIGS. 35 and 36 may be used for duck hunting, for example. As illustrated, the canvas showing in these figures may terminate short of the ground in the front, along the sides and in the rear.

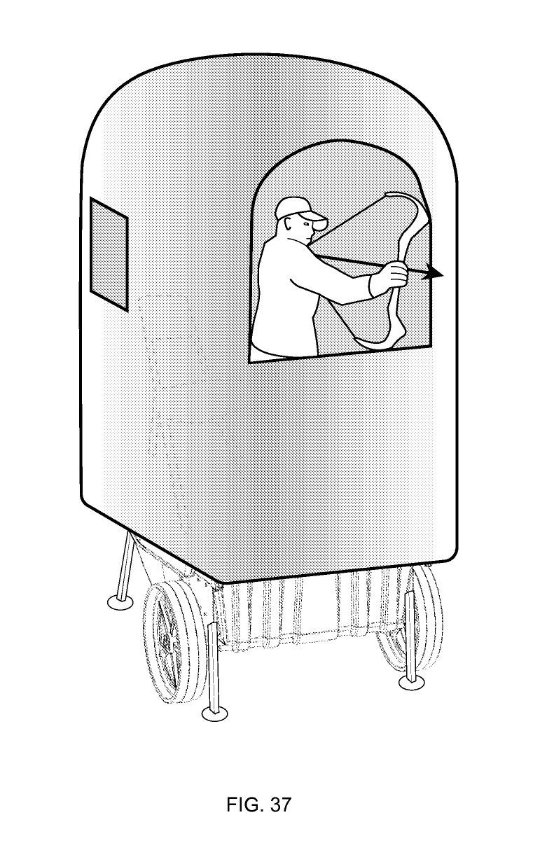

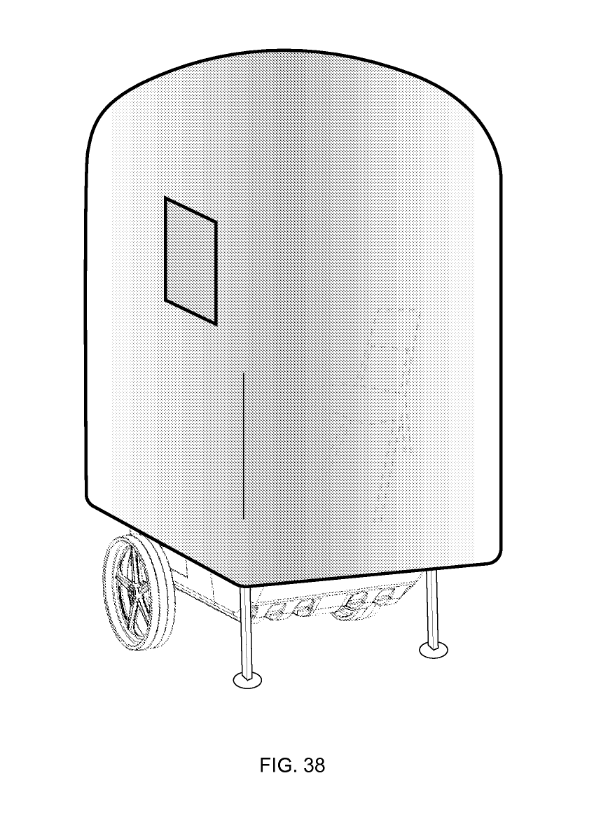

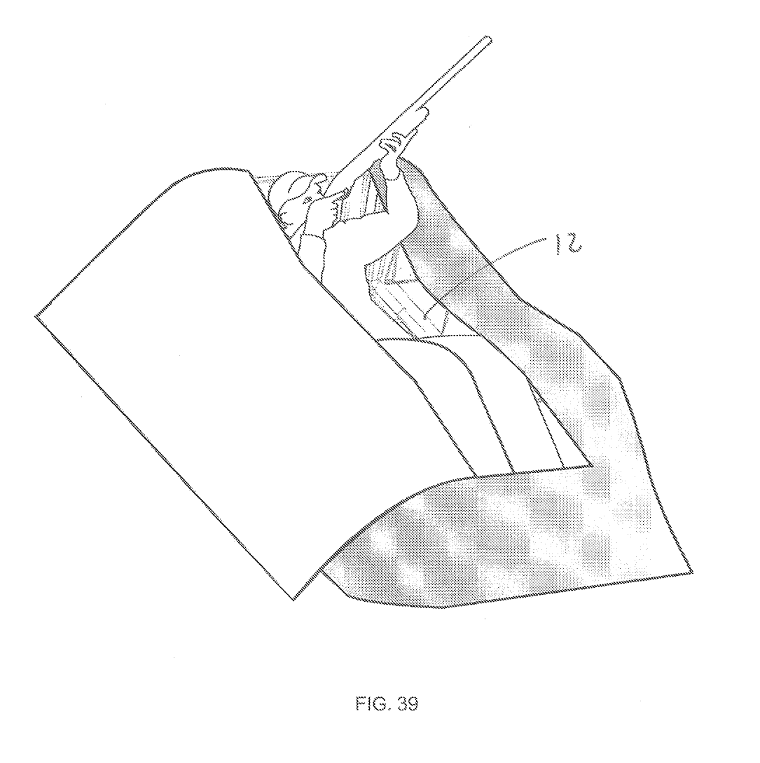

With reference to FIGS. 37 and 38, the apparatus for outdoorsmen of the present teachings is shown in another hunting orientation. As illustrated, the hunting orientation accommodates a single hunter for bow hunting, for example. The apparatus 10 includes an alternative mounted seat. As with the embodiment of FIGS. 33 and 34, for example, the apparatus 10 is shown to include 4 adjustable legs to be used when the tub is in a horizontal position (see other embodiments as well).

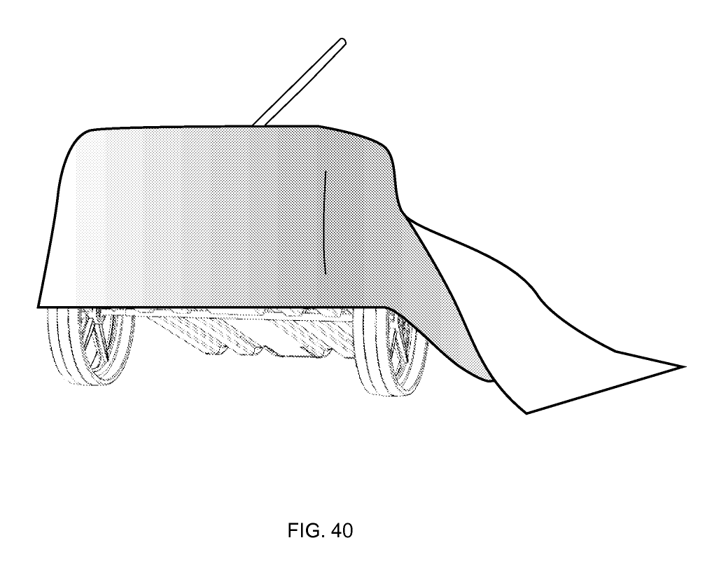

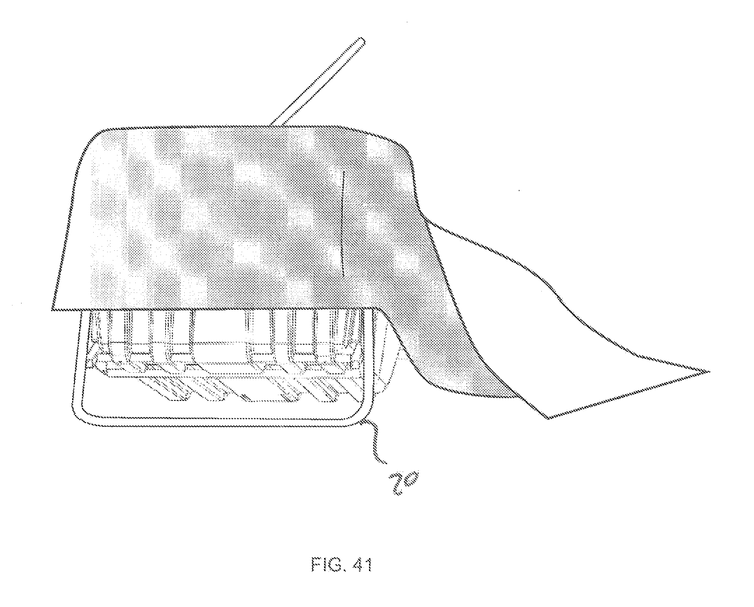

With reference to FIGS. 39 and 40, the apparatus for outdoorsmen of the present teachings is shown in yet another hunting orientation. As illustrated, the hunting orientation is particularly adapted to be used as a ground blind. The apparatus includes a cover that cooperates with the tub 12 to define an enclosure for the user. The cover may include a front flap that may be opened to provide ingress/egress or to allow the user to assume a shooting position. When the flap is closed, the cover conceals the hunter from prey and protects the hunter from the elements. The cover may simply be draped over the tub 12. Alternatively, the cover may be suitably secured to the tub 12 in any manner well known in the art.

For the use shown in FIGS. 39 and 40, the tub 12 preferably angles slightly downward from the rear to the front. As shown in FIG. 40, the rear of the tub 12 may be supported by the wheels 68 and the front of the tub 12 may simply rest on the ground.

FIG. 41 is a view similar to FIG. 40. In this application, the wheels 68 of the apparatus 10 have been removed and the tub 12 is supported proximate the rear end by the rear canopy support 20. In this regard, the rear canopy support 20 may be articulated to engage the ground and provide the desired angle of the tub 12.

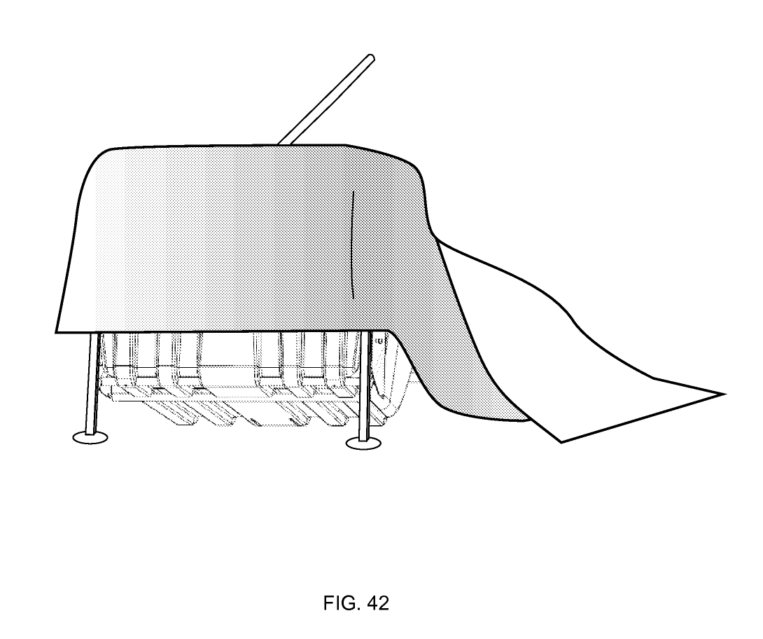

FIG. 42 is another view similar to FIG. 40. Again, the wheels of the apparatus 10 have been removed from the tub 12. The rear end of the tub 12 may be supported by a pair of adjustable legs to provide the desired angle of the tub 12. The legs may be independently adjustable.

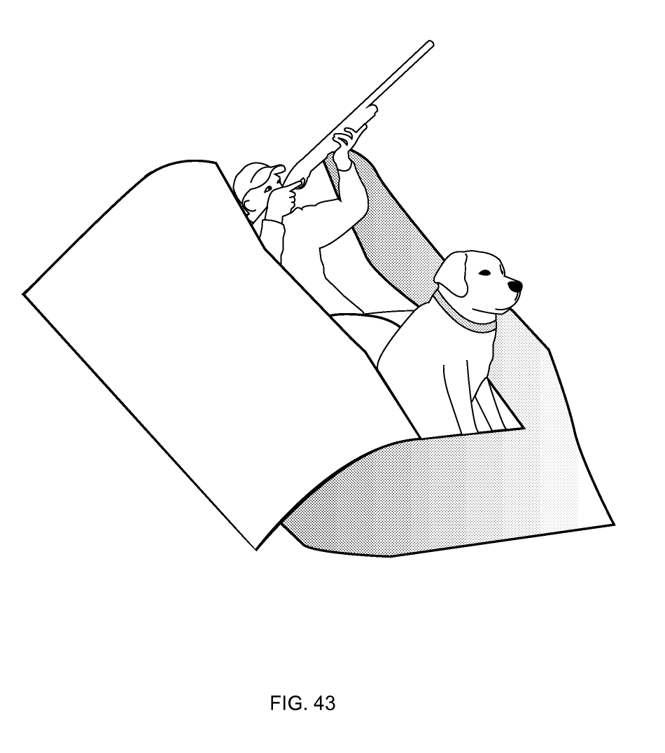

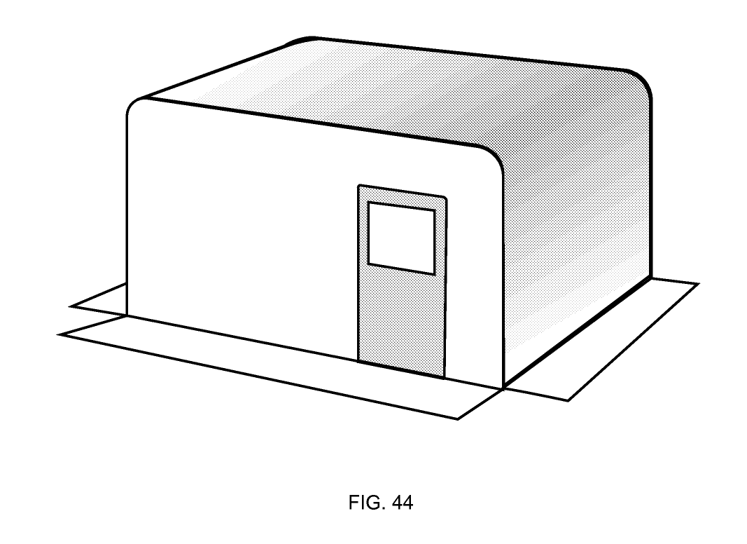

FIG. 43 is a front perspective view similar to FIG. 39 further illustrating a flexibility of the apparatus 10 of the present teachings to accommodate a dog.

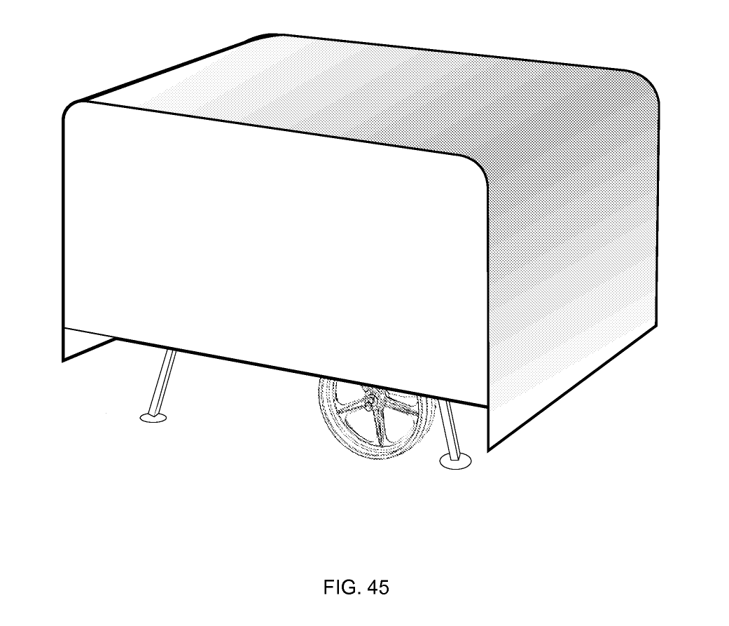

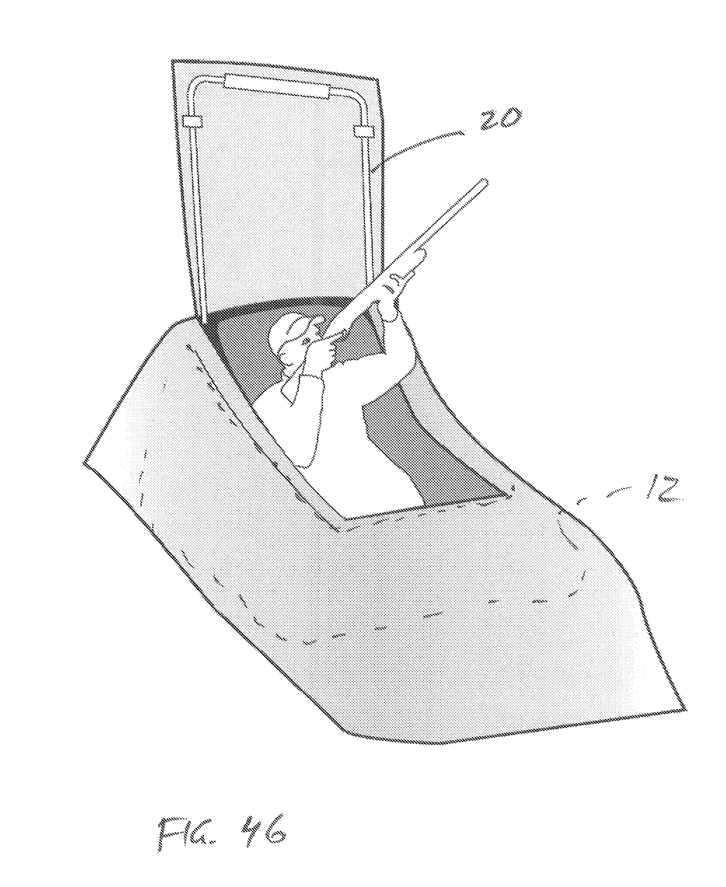

With reference to FIGS. 44 and 45, the apparatus of the present teachings is shown in an ice shanty orientation.

Turning to FIG. 46, the apparatus 10 of the present teachings is shown in the hunting orientation of FIG. 39 and is further shown with an alternative cover. As with the prior embodiments, the cover again cooperates with the tub 12 to define an enclosure for concealing and protecting the user. The cover defines an opening that is sized and configured to cooperate with the open upper side of the tub 12. In this regard, the opening is generally rectangular and the cover may be secured to the tub 12 to align the opening and the open upper side. The cover includes a flap. The flap may be movably supported by the rear canopy support 20. In a closed position, the flap closes the opening in the cover. The rear canopy support 20 may be articulated to an open position (as shown in FIG. 46) to open the opening. Opening of the flap may be assisted by a bungee cord or other device such that the flap may be quickly opened in response to upward gun movement by a hunter. A lower cross bar may be positioned at a foot location and a middle cross bar at a door location.

Accordingly, it will again be appreciated that the present teachings provide an apparatus for transporting hunting and fishing gear that also may be configured in various orientations to provide various shelters. In this regard, a single product that is provided that may be alternative oriented and equipped with multiple canvases to satisfy various hunting and fishing applications. The various canvases or covers may cooperate with the common tub 12 to define an enclosure for a user.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A multi-use apparatus comprising:
a common tub; and
at least one cover for cooperating with the common tub to define an enclosure for a user,
wherein the multi-use apparatus is operative in a transportation mode and a user enclosure mode in which a user is at least partially within the enclosure.

2. The multi-use apparatus of claim 1, wherein the enclosure defined by the tub and the at least one cover is defined by a storage area of the tub and an interior of the at least one cover.

3. The multi-use apparatus of claim 2, wherein the storage area of the tub is defined by a pair of side walls, a rear wall and a front wall.

4. The multi-use apparatus of claim 2, wherein the tub includes an open side and the cover peripherally surrounds the open side, the cover having a rear opening aligning with the open side.

5. The multi-use apparatus of claim 1, wherein the tub is oriented generally horizontally in the transportation mode and generally vertically in the user enclosure mode.

6. The multi-use apparatus of claim 5, wherein the apparatus further includes a plurality of legs rearwardly extending from the tub to support the tub in the user enclosure mode.

7. The multi-use apparatus of claim 5, wherein the apparatus further includes a plurality of canopy supports each coupled to the tub for movement between a stowed position and a deployed position.

8. The multi-use apparatus of claim 1, wherein the user enclosure mode is adapted for use as a ground blind.

9. The multi-use apparatus of claim 8, wherein the cover includes a flap movable from a closed position to an open position.

10. The multi-use apparatus of claim 9, wherein the apparatus further includes at least one canopy support member pivotably coupled to the tub, the flap secured to the canopy support member such that articulation of the canopy support member from a stowed position to a deployed position articulates the flap from a closed position to an open position.

11. The multi-use apparatus of claim 8, wherein the tub is generally horizontal in the transportation mode and is angled from the horizontal in the user enclosure mode.

12. The multi-use apparatus of claim 1, wherein the at least one canvas includes a plurality of canvases.

13. A multi-use apparatus for outdoorsmen comprising:
a common tub;
a first, second, third and fourth adjustable legs mounted to the tub, each of the legs including a mounting member and a telescopic member, each mounting member non-rotatably mounted to the tub,
wherein the tub is oriented in a generally horizontal position for transportation and a generally vertical position for hunting and the like.

14. The multi-use apparatus of claim 1, further comprising:
at least one cover for cooperating with the common tub to define an enclosure for a user,
wherein the multi-use apparatus is operative in a transportation mode and a user enclosure mode.

15. The multi-use apparatus of claim 14, wherein the enclosure defined by the tub and the at least one cover is defined by a storage area of the tub and an interior of the at least one cover.

16. The multi-use apparatus of claim 14, wherein the tub includes an open side and the cover peripherally surrounds the open side, the cover having a rear opening aligning with the open side.

17. A multi-use apparatus for outdoorsmen comprising:
a tub having an open side, the tub orientable to a user enclosure position in which the open side is in a generally vertically extending plane;
a plurality of canopy supports each pivotably coupled to the tub for movement between a stowed position and a deployed position, each canopy support orientable in a separate generally horizontal plane; and
a canopy cooperating with the tub to define an enclosure,
wherein the plurality of canopy supports support the canopy in the user position.

18. The multi-use apparatus of claim 17, wherein the enclosure defined by the tub and the at least one cover is defined by a storage area of the tub and an interior of the at least one cover; and
wherein the tub includes an open side and the cover peripherally surrounds the open side, the cover having a rear opening aligning with the open side.

19. The multi-use apparatus of claim 9, wherein the storage area of the tub is defined by a pair of side walls, a rear wall and a front wall.

20. The multi-use apparatus of claim 17, wherein the tub is oriented generally horizontally in the transportation position and generally vertically in the user enclosure mode.
